(19) United States
(12) Patent Application Publication
(10) Pub. No.: US 2014/0062278 A1
(43) Pub. Date: Mar. 6, 2014

(54) METHOD OF OPERATING A DOMESTIC APPLIANCE, AND DOMESTIC APPLIANCE HAVING AN ERGONOMIC OPERATOR CONTROL APPARATUS

(71) Applicant: DIEHL AKO STIFTUNG & CO. KG, Wangen (DE)

(72) Inventors: JOACHIM LYSZUS, BAINDT (DE); RALPH STOHR, LEUTKIRCH (DE); BRUNO FUHGE, OPFENBACH (DE)

(73) Assignee: DIEHL AKO STIFTUNG & CO. KG, Wangen (DE)

(21) Appl. No.: 14/013,685

(22) Filed: Aug. 29, 2013

(30) Foreign Application Priority Data
Aug. 29, 2012 (DE) 10 2012 017 091.2

(51) Int. Cl. G06F 3/0482; G06F 3/0488; G06F 3/0484; A47B 96/00; A47B 95/02

(52) U.S. Cl. CPC G06F 3/0482; A47B 96/00; A47B 95/02; G06F 3/04847; G06F 3/0488
USPC 312/294; 312/237; 715/810

(57) ABSTRACT

A domestic appliance has an operator control apparatus with at least one operator control element, and has a door for closing a functional area of the domestic appliance on which at least one handle apparatus for opening and closing the door is arranged. For the purpose of ergonomic operator control, the operator control apparatus is arranged at least partially in the immediate vicinity of a holding region of the handle apparatus so that a user can operate the operator control apparatus with the same hand with which he is holding the handle apparatus for opening or closing the door. There is also provided a method for setting an operator control program of a domestic appliance.

### CROSS-REFERENCE TO RELATED APPLICATION

This application claims the priority, under 35 U.S.C. §119, of German application DE 10 2012 017 091.2, filed Aug. 29, 2012; the prior application is herewith incorporated by reference in its entirety.

### BACKGROUND OF THE INVENTION

### Field of the Invention

The present invention relates to a method for setting a program of a domestic appliance having an operator control apparatus with at least one operator control element. The invention also pertains to a domestic appliance, in particular a domestic appliance having an ergonomic operator control apparatus with at least one operator control element.

The purpose of domestic appliances such as dishwashers, washing machines, tumble dryers, ovens, microwave ovens, cooktops, hobs, refrigerators, cabinet-type freezers and the like is, in principle, to treat (for example wash, dish-wash, dry, cook, etc.) the items loaded in the respective appliance, wherein the intended aim is to achieve a process result (for example clean laundry, etc.) which is as optimum as possible, a treatment time which is as short as possible and a consumption of resources (water, electricity, detergent, etc.) which is as low as possible. A further intended aim is to achieve, in addition to an aesthetically pleasing design of the domestic appliance, operator control of the domestic appliance which is as simple and ergonomic as possible.

United States patent application Pub. No. US 2009/0217920 A1 and its counterpart German published patent application DE 10 2006 001 246 A1 describe an operator control module with operator control and display elements, which operator control module is inserted into an oven door of a cooking appliance.

U.S. Pat. No. 8,003,923 B2 and its counterpart German published patent application DE 10 2007 015 569 A1 describe a light signal display which is integrated in an elongate door handle on a door of a domestic appliance. The operating means are arranged in a panel unit above the door.

European published patent application EP 2 380 479 A1 describes an operator control device with touch-sensitive operator control elements, which operator control device is in the form of a door handle and is arranged on the front of the door of a domestic appliance.

### BRIEF SUMMARY OF THE INVENTION

It is accordingly an object of the invention to provide a method of operating a household appliance and an appliance, which overcomes the above-mentioned disadvantages of the heretofore-known devices and methods of this general type and which provides for an improved method for setting a program of a domestic appliance and also an improved domestic appliance with an ergonomic operator control apparatus.

With the foregoing and other objects in view there is provided, in accordance with the invention, a method of setting a program of a domestic appliance having an operator control apparatus with at least one operator control element, the method comprising the steps of:

a) causing a list of selection options of a menu region to be displayed in a central input region of the at least one operator control element;

b) selecting a selection option in the central input region;

c) causing the list of selection options of the menu region to be removed from the central input region; and

d) starting the program of the domestic appliance.

In other words, the first-mentioned object in respect of a method is achieved by a method for setting a program of a domestic appliance having an operator control device with at least one operator control element, the method comprising the steps of: causing a list of selection options of a menu region to be displayed in a central input region; selecting a selection option in the central input region; causing the list of selection options of the menu region to be removed from the central input region; starting the program.

With the above and other objects in view there is also provided, in accordance with the invention, a domestic appliance, comprising:

a door for closing, and enabling access to, a functional area of the domestic appliance;

a handle apparatus for manually opening or closing the door mounted on the door, the handle apparatus having a holding region;

an operator control apparatus with at least one operator control element, and a control device connected to the operator control element for carrying out the above-outlined method;

wherein the operator control apparatus is disposed, at least partially, in an immediate vicinity of the holding region of the handle apparatus for opening and closing a door, to thereby enable a user to operate the operator control apparatus with a same hand with which the user is holding the handle apparatus for opening or closing the door.

In other words, the domestic appliance according to the invention has an operator control apparatus with at least one operator control element, a door for closing a functional area of the domestic appliance on which at least one handle apparatus for opening and closing the door is arranged, and a control means for carrying out the method. The operator control apparatus is arranged at least partially in the immediate vicinity of a holding region of the handle apparatus so that a user can operate the operator control apparatus with the same hand with which he is holding the handle apparatus for opening or closing the door.

In the domestic appliance according to the invention, closing and operating and operating and opening the domestic appliance are combined with one another in such a way that a user can carry out all of the required operator control steps of the method using just one handle. The user can operate the operator control apparatus using just one hand, more precisely using a thumb or a finger of the hand, without having to remove the said hand from the handle apparatus of the door. In this case, the handle apparatus can be used at the same time as a physical reference for the operation of the operator control apparatus. The domestic appliance which is designed in such a way therefore allows for particularly ergonomic and simple operator control by a user.

In this context, an operator control apparatus is to be understood as any type of apparatus which has at least one operator control element which can be operated by a user in order to control a function of the respective domestic appliance. Depending on the domestic appliance, these functions may include an on/off operation, a washing program, a dishwashing program, a washing temperature, a spin-drying rotation speed, a cooking stage, a time period, etc. The operator control apparatus preferably has one, two, three, four or more operator control elements. When there are several, that is to say at least two, operator control elements, the said operator control elements may be identical or different operator control elements. The operator control elements are preferably designed in the form of a (push)button, a rotary knob, a slide controller or the like. The operator control apparatus is preferably connected to a control means of the respective domestic appliance in a wireless manner (for example by radio) or via a cable connection.

In this context, a handle apparatus is to be understood as any type of apparatus which is or can be fitted to an appliance door and can be operated by a user in order to open or to close the appliance door. The appliance door preferably undergoes a pivoting movement during the opening and closing processes. The handle apparatus is preferably designed in the form of a recessed handle, an elongate rod-type handle or a lever-type handle. In a preferred refinement, the handle apparatus additionally has a device for unlocking and locking the door in its closed state.

In this context, the holding region of the handle apparatus denotes a region of the handle apparatus which a user can hold with his hand in order to operate the handle apparatus. Depending on the type and size of handle apparatus, the said handle apparatus is physically greatly limited and allows a hand of a user to be positioned substantially only in one way (for example in the case of a recessed handle as the handle apparatus) or is physically expanded and allows a hand of a user to be positioned in different ways (for example in the case of an elongate rod-type handle as the handle apparatus). In the first-mentioned case, the handle apparatus provides exactly one holding region, the operator control apparatus then being arranged in the immediate vicinity of the said holding region according to the invention. In the last-mentioned case, the handle apparatus provides a highly extended holding region or several holding regions; in this case, the only part of the said handle apparatus which is to be understood as a holding region within the meaning of the invention is a part which has the operator control apparatus arranged in the immediate vicinity. In other words, the user has to hold, for example, a rod-type handle in a predetermined holding region in order to be able to simultaneously also operate the operator control apparatus with the same hand. However, the user will intuitively be able to hold the handle apparatus in the predetermined holding region by virtue of the operator control apparatus which can be clearly seen by the user.

In an advantageous development, touching, tapping or pressing the menu region causes the list of selection options of the menu region to be displayed in the central input region or to be removed from the central input region.

Touching, tapping or pressing the menu region opens or closes a menu in which a list of selection options, such as washing, dishwashing, refrigerating, cooking or baking programs, is compiled, the said list being displayed in the central input region.

In a preferred alternative, calling up the menu region causes the list of selection options of the menu region to be displayed in the central input region, and shutting down the menu region causes the list of selection options of the menu region to be removed from the central input region.

Calling up or shutting down the menu region, that is to say by a swiping movement, opens or closes a menu in which a list of selection options, such as washing, dishwashing, refrigerating, cooking or baking programs, is compiled, the said list being displayed in the central input region. As an alternative, a list of selection options which is displayed in a further display is moved into the central input region or moved out of the said central input region by a call-up operation or, respectively, a shut-down operation.

In a further embodiment, the selection option in the central input region is selected by touching, tapping or pressing.

Further selectable options are advantageously displayed in the central input region after a selection option is selected.

In a further refinement, the selected selection option is visually highlighted.

In an advantageous development, the list of selection options is hidden in the central input region, is displayed on a display outside the central input region or is permanently shown outside the central input region by a legend on a front portion of the domestic appliance.

In a preferred alternative, an image of the legend on the appliance front is pulled into the central input region or is removed from the central input region by being moved out. An image of the legend is pulled into the central input region or removed from the said central input region by a swiping movement, with the result that the legend and the image of the said legend are visible. In this case, the legend can be shown less strikingly than the image, for example by virtue of damped lighting or concealed colours.

In a further embodiment, the selection option which corresponds to a selection option which is selected in the central input region is highlighted in the list of selection options which is permanently shown on the appliance front. A selection marker which is displayed in the central input region is transferred to the corresponding selection option in the list of selection options which is permanently shown on the appliance front. The transferred selection marker can be, for example, an optical signal.

In a preferred refinement of the invention, the operator control apparatus has at least one touch-sensitive operator control element, preferably a touch-and-slide operator control element. The operator control apparatus is preferably designed as a touch-operated operator control apparatus or as a touch-and-slide operator control apparatus. The operator control apparatus can preferably be operated by swiping and tapping movements of a thumb or finger, in a similar manner to a smartphone.

In a preferred refinement of the invention, the operator control apparatus is integrated in the handle apparatus of the door. The operator control apparatus preferably forms a physical unit with the handle apparatus.

In another preferred refinement of the invention, the operator control apparatus is arranged on the door. The operator control apparatus is preferably at least partially inserted into the door or mounted on the door. In this case, the operator control apparatus can be arranged in the region of the door front, which faces the user, or in the region of the end face of the door.

Further subjects of the invention are a handle apparatus for opening and closing a door, an operator control apparatus with at least one operator control element, and a door for closing a functional area, these subjects each being designed for use in a domestic appliance of the invention as described above.

The present invention can be used, in principle, in any domestic appliances, in particular large domestic appliances. In this context, the said domestic appliances include, in particular, dishwashers, washing machines, tumble dryers, ovens, hobs, microwave ovens, refrigerators, cabinet-type freezers, chest freezers and the like.

Other features which are considered as characteristic for the invention are set forth in the appended claims.

Although the invention is illustrated and described herein as embodied in a method for operating a domestic appliance, and domestic appliance having an ergonomic operator control apparatus, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 shows a schematic sectional side view of a domestic appliance according to a first exemplary embodiment of the present invention;

FIG. 2 shows a schematic sectional side view of a domestic appliance according to a second exemplary embodiment of the present invention;

FIG. 3 shows a schematic sectional side view of a domestic appliance according to a third exemplary embodiment of the present invention;

FIGS. 4A to 4E show various schematic views for illustrating the manner of operation of an operator control apparatus of a domestic appliance according to one exemplary embodiment of the present invention; and

FIGS. 5A to 5C show various schematic views for illustrating the manner of operation of an operator control apparatus of a domestic appliance according to a further exemplary embodiment of the present invention.

### DESCRIPTION OF THE INVENTION

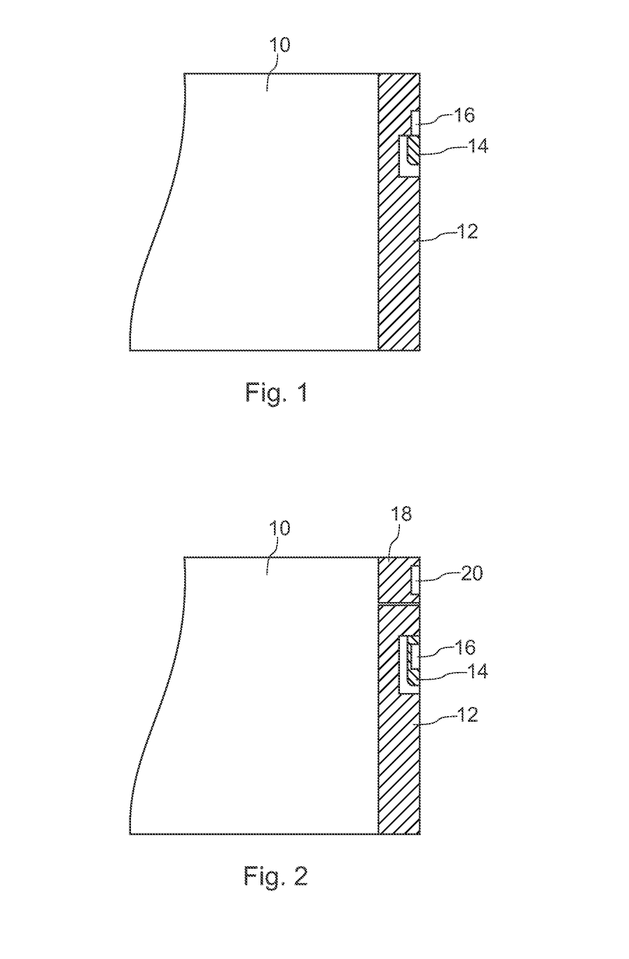

Referring now to the figures of the drawing in detail and first, particularly, to FIGS. 1 to 3, thereof, there is shown, by way of example, a dishwasher representing a domestic appliance for the purposes of the invention. The dishwasher has a main structure or body 10 which defines a corresponding functional area in its interior. An (appliance) door for closing this functional area is provided in the front region of the dishwasher (on the right-hand side in FIGS. 1 to 3). The front region faces towards the user.

The door 12 is, for example, mounted on the body 10 such that it can pivot. It can be moved, in particular, between a position which closes the functional area (illustrated in FIGS. 1 to 3 in each case) and an open position which allows access to the functional area (for example folded-open downwards and to the right in FIGS. 1 to 3).

In the exemplary embodiment of FIG. 1, the door 12 extends substantially over the entire front region of the main structure 10. A recessed handle 14 is arranged in the door front as a handle apparatus in the vertically upper and laterally central region of the door 12.

The recessed handle 14 is connected to an unlocking apparatus (not illustrated), with the result that the door 12 can be unlocked at the same time as the recessed handle 14 is grasped in order to open the door 12. When the door 12 is closed, it is preferably automatically locked by the locking apparatus being prestressed, for example, in its locking position.

An operator control apparatus 16 is inserted into the door front directly above the recessed handle 14. The operator control apparatus 16 preferably has at least one touch-sensitive operator control element. When grasping the recessed handle 14, the user can operate the said operator control apparatus 16 using his hand or his thumb or a finger of the hand on account of the immediate proximity of the operator control apparatus 16 to the holding region of the recessed handle 14, without having to remove his hand from the recessed handle for this purpose.

The user can therefore operate the dishwasher, that is to say for example switch the said dishwasher on and off, select a dishwashing program, set a dishwashing temperature, etc., in a very ergonomic manner while opening or closing the door.

The operator control apparatus 16 in the door 12 is, for example, connected or coupled to a control means (not illustrated) of the dishwasher by radio, that is to say wirelessly. The control means is located, for example, in the main structure 10 of the dishwasher and controls, in particular, the supply of water, the discharge of water and the heating of the dishwasher.

The exemplary embodiment shown in FIG. 2 differs from the above exemplary embodiment in that the operator control apparatus 16 is not positioned in the door 12, but rather directly in the recessed handle 14. The operator control apparatus 16 is therefore located in the immediate vicinity of the holding region of the operator control apparatus, with the result that ergonomic operator control of the dishwasher is likewise possible in this case.

Furthermore, in the exemplary embodiment of FIG. 2, a panel 18 is additionally provided on the front of the dishwasher, the said front facing the user, above the door 12. That is to say, the door 12 does not extend over the entire appliance front in this exemplary embodiment.

This panel 18 can be designed as a simple decorative panel or at least partially as an operator control panel. In the case of an operator control panel 18, a display and/or operator control unit 20 is integrated in the said panel, the said display and/or operator control unit displaying further information about the operating state, the dishwashing program set, etc. to the user and—in addition to the operator control apparatus 16 in the recessed handle 14—providing further input options.

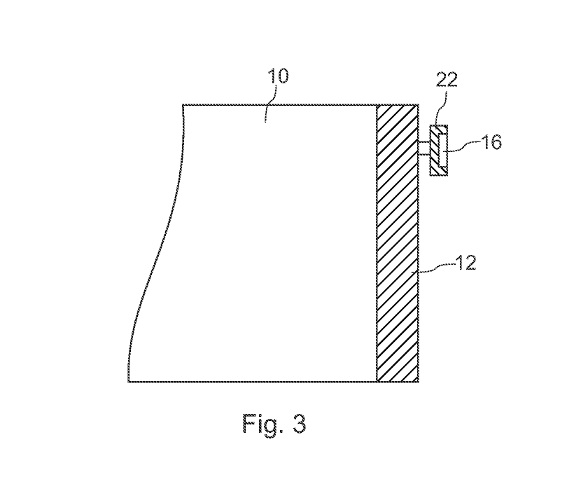

A panel 18 of this kind can also be provided in the case of the exemplary embodiments of FIGS. 1 and 3, even if this is not shown separately.

The exemplary embodiment of FIG. 3 differs from the above exemplary embodiments in particular by virtue of the type of handle apparatus. In this case, the handle apparatus is in the form of an elongate rod-type handle 22 which is fitted to the door 12 in the vertically upper region of the said door and extends in the width direction of the door 12 (in a direction perpendicular to the plane of the drawing) over a large portion, for example approximately 50% to approximately 85%, of the door 12.

Since the holding region of the handle apparatus for the user is somewhat spaced apart from the door 12 in the case of the rod-type handle 22, the operator control apparatus 16 is integrated in the rod-type handle in this exemplary embodiment. The region in which the operator control apparatus 16 is incorporated in the rod-type handle 22 forms the holding region of the rod-type handle 22 within the meaning of the invention. However, as an alternative, the operator control apparatus can also be arranged in/on the door 12 in the immediate vicinity of the rod-type handle 22 in this case.

In the dishwasher according to one of these exemplary embodiments, the user can carry out all the required operator control steps using only one handle, wherein his/her hand can remain on the respective handle apparatus. In this case, operator control of the dishwasher may take place, for example, as follows:

a) the door 12 is closed using the hand on the recessed handle 14 or the rod-type handle 22;

b) the hand of the user remains on the recessed handle 14 or the rod-type handle 22;

c) the desired dishwashing program is selected using the thumb on the operator control apparatus 16;

d) a desired option for the selected dishwashing program is selected using the thumb on the operator control apparatus 16;

e) the dishwashing program is started using the thumb on the operator control apparatus 16; and

f) the recessed handle 14 or the rod-type handle 22 is released.

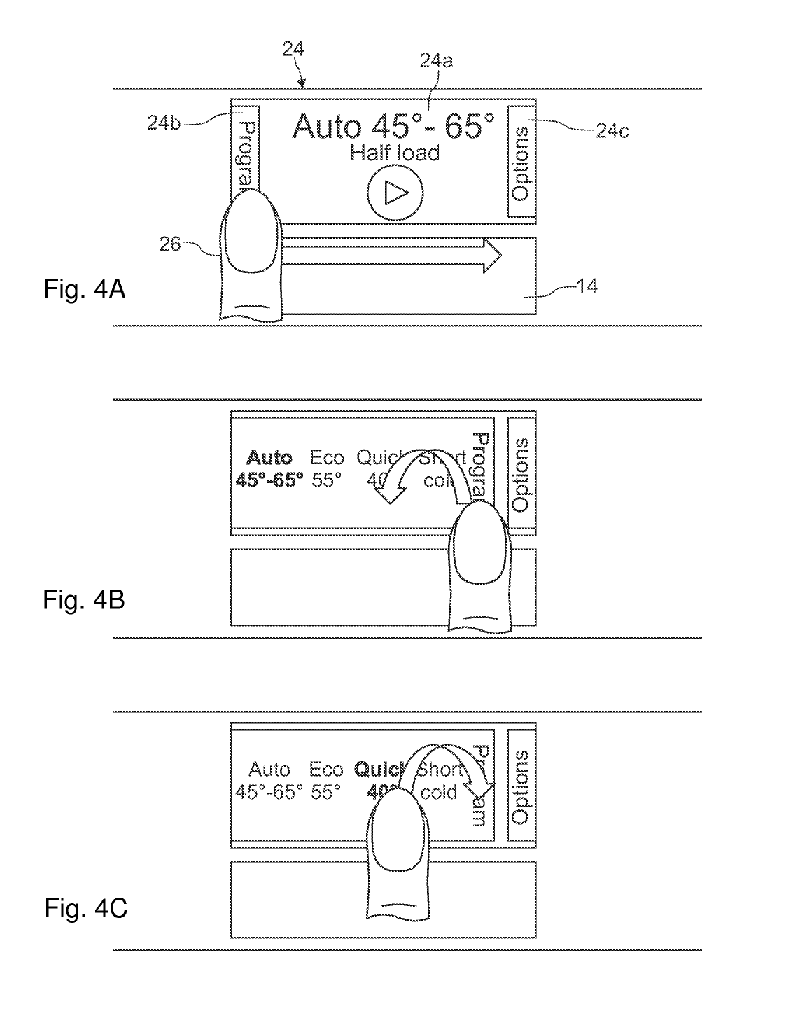

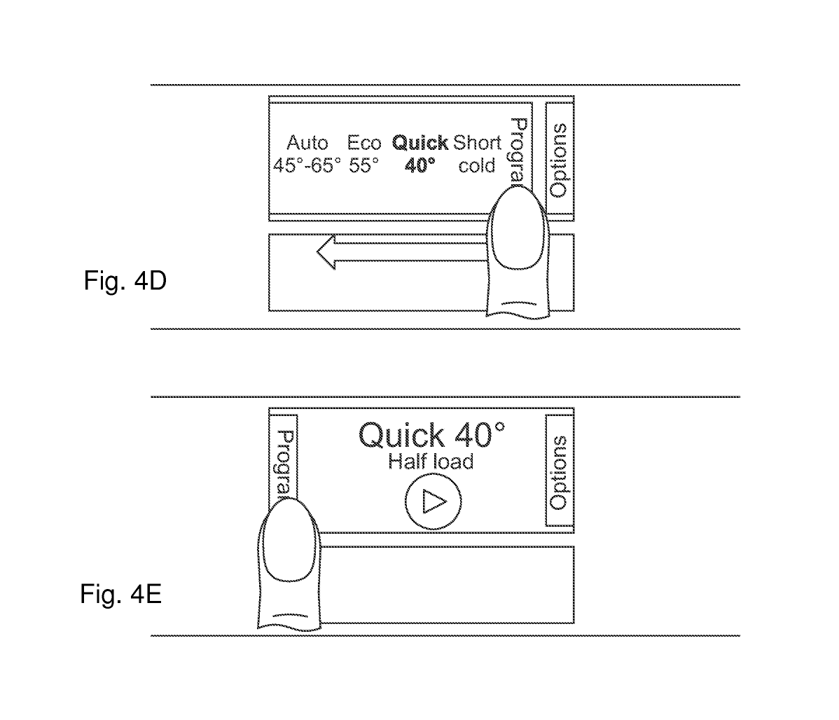

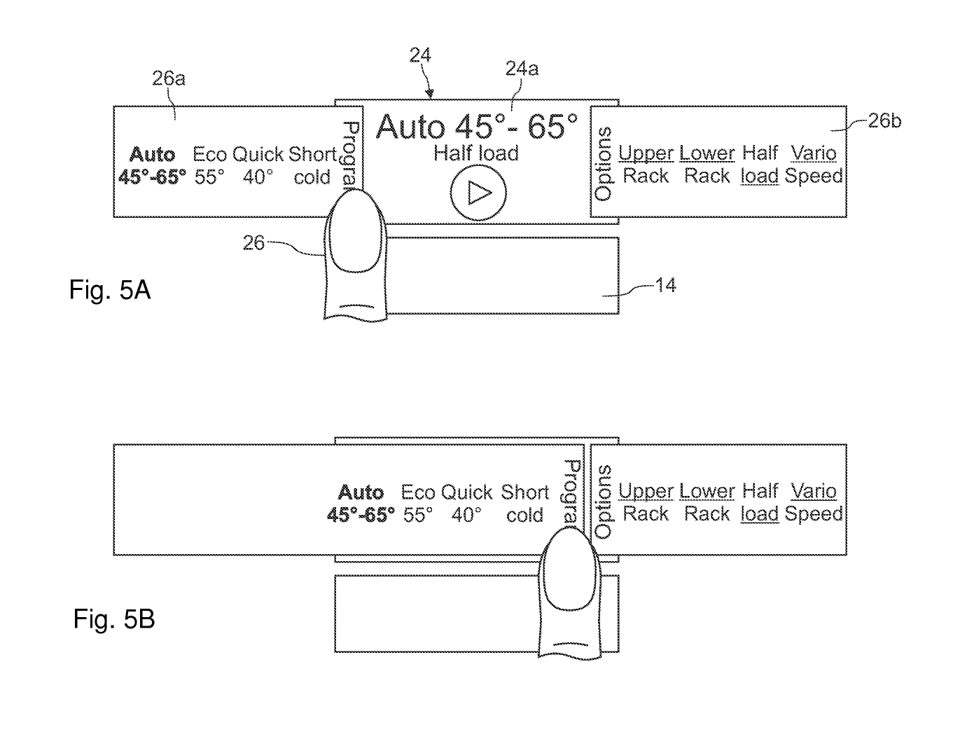

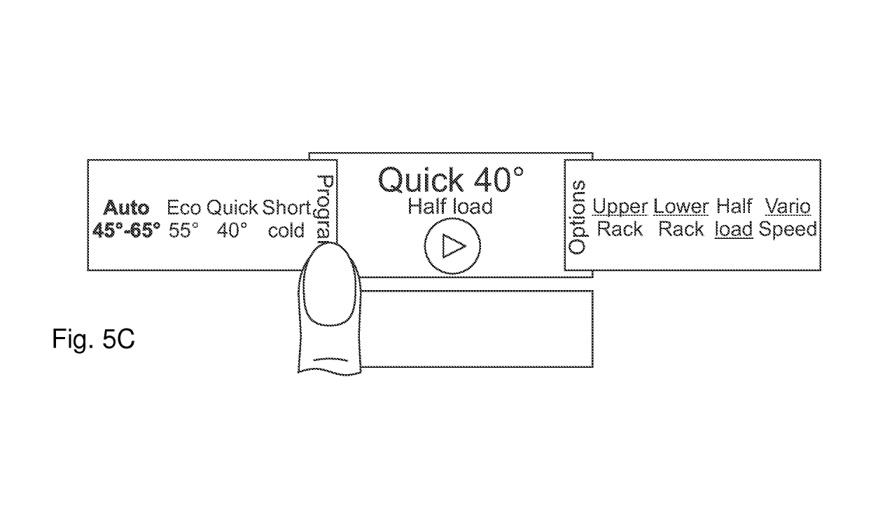

The design and manner of operation of an operator control apparatus 16 as can be used in the above-described dishwashers will now be explained in greater detail with reference to FIGS. 4 and 5.

In the exemplary embodiment of FIG. 4 (illustrated as a sequence in FIGS. 4A to 4E), the operator control apparatus 16 which is arranged directly above the recessed handle 14 has a touch-and-slide operator control element 24 as the touch-sensitive operator control element. This touch-and-slide operator control element 24 contains a central input region 24a, which can be operated by brief tapping or pressing, and two menu regions 24b and 24c on either side of the input region 24a, it being possible to call up the said menu regions. The input region 24a serves as a display region at the same time. Overall, the operator control apparatus 16 can be operated in a similar manner as a smartphone.

The operator control apparatus 16 can be operated, for example, using the thumb 26 of the hand of the user in the holding region of the recessed handle 14.

In the basic state (FIG. 4A), the currently set dishwashing program and the currently set options are displayed to the user in the central input and display region 24a of the operator control element 24 of the operator control apparatus 16. If these instructions already correspond to what the user desires for the next dishwashing process, the said user can start the dishwashing program simply by tapping the input region (“play” symbol).

Otherwise, the dishwashing program and options can be changed by the user as follows.

In a first step (FIG. 4B), the user pulls open the “Program” menu 24b to the right, with the result that all of the available dishwashing programs are displayed in the central input and display region 24a. After the desired dishwashing program (in this case: “Quick 40°”) is selected by tapping the corresponding menu item in FIG. 4C, the user pulls closed the “Program” menu 24b again to the left using his thumb 26 (FIG. 4D). The set dishwashing program “Quick 40°” with the currently set or preset option “Half load” is now displayed to the user in the central input and display region 24a of the operator control element 24 (FIG. 4E).

The user can now start this dishwashing program “Quick 40°, Half load” by tapping the input region 24a using his thumb 26 or change the options from the “Options” menu 24c in the same way as the dishwashing program.

In the exemplary embodiment of FIG. 5 (illustrated as a sequence in FIGS. 5A to 5C), the operator control apparatus 16 has a wider appearance in comparison to the exemplary embodiment of FIG. 4.

In the basic state of FIG. 5A, two display regions 26a and 26b are provided laterally next to the central input and display region 24a of the touch-and-slide operator control element 24, the said display regions displaying all of the menu items of the “Program” and “Options” menus to the user.

In order to set a desired dishwashing program, the user pulls open the “Program” menu to the right into the central input region 24a using his thumb 26 in this case too (FIG. 5B), in order to select the desired dishwashing program by briefly tapping the corresponding menu item. The “Program” menu is then moved to the side to the left again (FIG. 5C) and a desired option can be now set in a similar manner or the dishwashing program can be directly started.

In this example, actual input is performed only in the central input and display region 24a. That is to say, only this central region of the operator control apparatus 16 has to be designed as a touch-sensitive operator control element 24, in this case as a touch-and-slide operator control element.

In a further exemplary embodiment (not shown), all of the menus 26a, 26b can be designed as a simple imprint (instead of a display as in FIG. 5). Another permanent legend could be formed, for example, by apertures or recesses in an appliance front or an operator control panel, it further being possible for the said legend to be illuminated. A combination comprising an imprint with an associated optical display is also possible. In order to change the settings, these menus can, as described above in FIG. 5, be pulled into the central input and display region 24a.

Instead of the touch-and-slide operator control elements 24 which are explained above with reference to FIGS. 4 and 5, the operator control apparatus 16 can also have one or more touch-operated operator control elements which can be operated by simple tapping or pressing. For example, the operator control apparatus 16 contains a number of touch-sensitive touch-operated operator control elements which corresponds to the available dishwashing programs.

Furthermore, the touch-sensitive operator control elements of the operator control apparatus can also be designed as simple (push)buttons or as rotary knobs, slide controllers, double-function buttons and the like.

1. A method of setting a program of a domestic appliance having an operator control apparatus with at least one operator control element, the method comprising the steps of:
a) causing a list of selection options of a menu region to be displayed in a central input region of the at least one operator control element;
b) selecting a selection option in the central input region;
c) causing the list of selection options of the menu region to be removed from the central input region; and
d) starting the program of the domestic appliance.

2. The method according to claim 1, which comprises touching, tapping or pressing the menu region to cause the list of selection options of the menu region to be displayed in the central input region or to remove the selection options from the central input region.

3. The method according to claim 1, which comprises pulling open the menu region to cause the list of selection options of the menu region to be displayed in the central input region, and pulling closed the menu region to cause the list of selection options of the menu region to be removed from the central input region.

4. The method according to claim 1, which comprises selecting a given selection option in the central input region by touching, tapping or pressing.

5. The method according to claim 1, which comprises causing further selectable options to be displayed in the central input region after a selection option is selected.

6. The method according to claim 1, which comprises visually highlighting the selected selection option.

7. The method according to claim 1, wherein the list of selection options is hidden in the central input region, is displayed on a display outside the central input region or is permanently shown outside the central input region by a legend on a front portion of the domestic appliance.

8. The method according to claim 7, which comprises pulling an image of the legend on the appliance front into the central input region or removing the image of the legend from the central input region by being moved out.

9. The method according to claim 7, which comprises causing the selection option which corresponds to a selection option that is selected in the central input region to be highlighted in the list of selection options which is permanently shown on the front portion of the domestic appliance.

10. A domestic appliance, comprising:
a door for closing, and enabling access to, a functional area of the domestic appliance;
a handle apparatus for manually opening or closing the door mounted on said door, said handle apparatus having a holding region;
an operator control apparatus with at least one operator control element, and a control device connected to said operator control element for carrying out the method according to claim 1;
wherein said operator control apparatus is disposed, at least partially, in an immediate vicinity of said holding region of said handle apparatus for opening and closing a door, to thereby enable a user to operate said operator control apparatus with a same hand with which the user is holding said handle apparatus for opening or closing said door.

11. The domestic appliance according to claim 10, wherein said operator control apparatus includes at least one touch-sensitive operator control element.

12. The domestic appliance according to claim 10, wherein said operator control apparatus includes at least one touch-and-slide operator control element.

13. The domestic appliance according to claim 10, wherein said operator control apparatus is integrated in said handle apparatus of said door.

14. The domestic appliance according to claim 10, wherein said operator control apparatus is arranged on said door.

15. In combination with the domestic appliance according to claim 10, comprising a handle apparatus for opening and closing a door.

16. In combination with the domestic appliance according to claim 10, an operator control apparatus having at least one operator control element.

17. In combination with the domestic appliance according to claim 10, a door for closing a functional area of the domestic appliance and having the operator control apparatus mounted thereon in functional vicinity of a door handle of said door.
